(19) United States
(12) Patent Application Publication
(10) Pub. No.: US 2004/0237373 A1
(43) Pub. Date: Dec. 2, 2004

(54) Flying decoy and support pole

(76) Inventor: Allen Coleman, Kemah, TX (US)

Correspondence Address: William P. Glenn, Jr., Suite 205, 2102 Mechanic Street, Galveston, TX, 77550, US

(21) Appl. No.: 10/447,422

(22) Filed: May 29, 2003

(51) Int. Cl. A01M 31/06

(52) U.S. Cl. 43/3

(57) ABSTRACT

A bird decoy representing a bird in flight and a support pole for such decoys. The decoy is a top view of a bird flying with outstretched wings, a head, neck, and body made from a single piece of relatively flat material. The decoy has a suspension rod which is attached on one end to the decoy. The free end of the suspension rod is inserted into a hole on a support pole. The support pole has numerous holes along its length for attaching several decoys. Several decoys are attached to the support pole and the pole is positioned vertically from ground level.

### FIELD OF INVENTION

The invention relates to decoys used to attract birds such as ducks or geese. More specifically, the invention relates to decoys which mimic birds in flight and to a support pole used to suspend one or more decoys above the ground.

### BACKGROUND OF THE INVENTION

For many years decoys of many types have been used to attract wild game birds such as ducks or geese. It is known in the prior art to provide decoys which mimic birds in flight or preparing to land. Some examples of such decoys known in the prior art are as follows.

U.S. Pat. No. 5,003,722 to Berkley et. al. teaches a body portion and wing portion cut from flexible sheet plastic foamed material assembled to represent the silhouette of a flying bird. The only movement achieved by this decoy is slight fluttering of the wing and body portions when the decoy is affected by wind. The intention of mounting the decoy directly to a stationary pole does not allow for vertical or horizontal movement of the entire decoy. Additionally, only one decoy may be attached to a support pole. These aspects are undesirable to the user.

U.S. Pat. No. 4,911,384 to Stankus teaches a winged kite with a body attached to a flat sheet lift member forming two wings and a tail. This kite type of decoy is capable of vertical and horizontal movement but it is solely dependent upon a certain wind velocity to maintain the decoy above ground level. Additionally, kite decoys may exhibit erratic, unnatural movement in high winds or the kit may fall to the ground in variable winds. These aspects are undesirable to the user.

U.S. Pat. No. 5,551,923 to Worzella teaches a simulated articulated bird with wind activated flapping wings. This decoy is mounted to a stationary support pole and achieves only the movement of the flapping wings when a certain wind velocity affects the decoy.

It is desirable to have a decoy representing a bird in flight which moves in a realistic manner when affected by wind. It is also desirable for the decoy to remain suspended above the ground when the wind loses velocity or if there is no wind present. It is also desirable to have a decoy which may be attached to a support pole in a manner that allows for several decoys to be attached to the same pole. It is also desirable for the support pole to be flexible, or mounted on a flexible ground stake, so that the attached decoys may achieve greater motion.

### SUMMARY OF THE INVENTION

The present invention is directed primarily toward decoys used to attract ducks and geese, but may be adapted to attract other birds as well scare away other birds or animals. In the preferred embodiment of the present invention a decoy having a profile shape of a flying bird is cut from a semi-rigid, flat material such as corrugated plastic sheet. The decoy has a suspension rod of thin, flexible construction affixed to a lower side of the decoy. The decoy is printed, painted, or otherwise made to resemble a specie of bird.

A support pole is described for the purpose of attaching one or more decoys so that they are suspended above the ground. The support pole is provided with a series of holes along its length for the purpose of insertion of the free end of the suspension rod from a decoy into the hollow interior of the support pole. When a sufficient length of the suspension rod is inserted into a hole in the support pole, the user releases the suspension rod and the decoy is suspended above the ground. Suspended in this way, a decoy may move vertically, horizontally, and at various angles when affected by wind. Several decoys may be suspended from a single support pole to resemble a small group of birds taking off, flying and/or landing. Each decoy may move independently when affected by wind giving the appearance of birds ascending, flying or descending.

Additionally, the support pole is preferably semi-flexible in its construction which helps to add movement to the decoys attached to it. The support pole is pushed into the ground at its lower end thereby extending a substantial portion of an upper end substantially vertical above the ground.

Alternatively, a ground stake may be used for the purpose of maintaining the support pole in a vertical position. The ground stake is smaller in diameter than the interior of the support pole so that a portion of lower end of the support pole may be placed over the upper end of a stake which is pushed into the ground. In another embodiment, the ground stake is constructed of a semi-flexible material to encourage movement of the support pole without requiring the support pole to be constructed of a semi-flexible material.

An object of the present invention is to provide an original and effective decoy system which mimic birds in flight.

An additional object of the present invention is to provide decoys which mimic birds in flight in a realistic manner when there is little or no wind present.

A further object of the present invention is to provide such decoys which are capable of a broad range of movement when affected by Wind.

Another object of the present invention is to provide a support pole which supports and encourages movement of a number of decoys.

### BRIEF DESCRIPTION OF THE DRAWINGS

FIG. 1 is a plan view of a decoy and suspension rod.

FIG. 2 is an elevation view of a plurality of decoys attached to a support pole by a suspension rod.

### DETAILED DESCRIPTION OF THE INVENTION

Detailed embodiments of the present invention are disclosed herein. It is to be understood, however, that the disclosed embodiments are merely exemplary of the invention that may be embodied in various and alternative forms. The figures are not necessarily to scale where some features may be exaggerated or minimized to show details of particular components. Therefore, specified structural and functional details disclosed herein are not to be interpreted as limiting, but merely as a basis for the claims and as a representative basis for teaching one skilled in the art to variously employ the present invention.

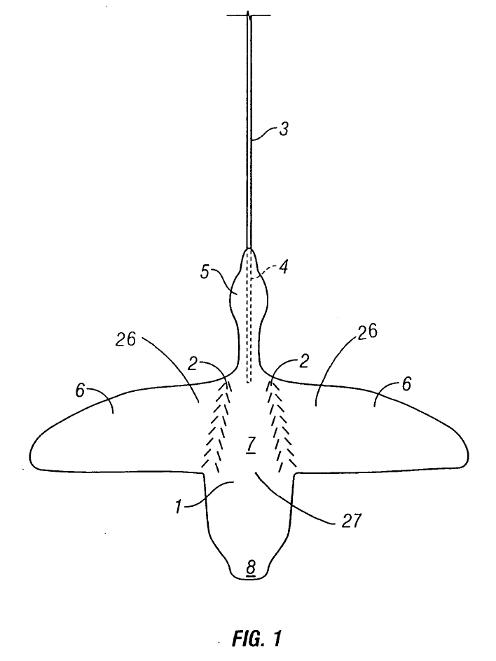

Referring to FIG. 1, decoy 1 is formed or cut in the shape of a top profile or plan view of a flying bird with outstretched wings 6. Decoy 1 is preferably cut from lightweight relatively flat material. In a preferred embodiment, decoy 1 is formed from corrugated plastic sheet material as a single piece. Bends, creases and/or joints 02 are made between wing portions 6 to a main body portion 7 of decoy 1. FIG. 1 depicts a preferred embodiment wherein joints 02 are a plurality of slits interposed between wings 6 and main body 7. Additional bends, creases or joints 02 may be made at points along wing portions 6 to form wings 6 into various positions, above or below a plane occupied by the main body portion 7. The upper and lower surfaces of decoy 1 are painted, printed, or otherwise decorated with lifelike details to mimic a specie of bird.

A first end 4 of a flexible suspension rod 3 is fixedly attached to decoy 1 at head and neck portion 5 of decoy 1. In a preferred embodiment, first end 4 of a flexible suspension rod 3 is fixedly attached to decoy 1 at the tail portion 8 of decoy 1. The flexible suspension rod 3 may be permanently attached to decoy 1 by a weatherproof glue or releaseably fixed to decoy 1 by a socket (not shown) fixed to decoy 1 and adapted to receive first end 4 of a flexible suspension rod 3. Flexible suspension rod 3 is constructed of a thin, yet fairly rigid material such as metal, plastic or graphite. Flexible suspension rod 3 may include a circular, arcuate or polygonal cross sections and may further include an annular or solid cross section.

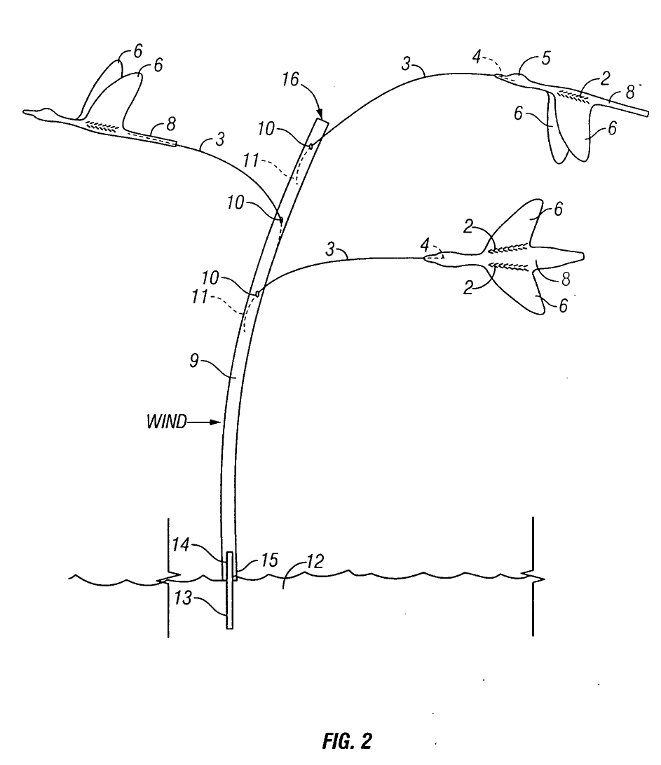

FIG. 2 depicts a plurality of decoy 1 attached to a support pole 9. Support pole 9 is a length of semi-rigid material capable of supporting a plurality of suspension rods 3 and decoys 1 and encourage movement of said decoys 1. Support pole 9 may be constructed of material such as metal, plastic or graphite. Support pole 9 may include a circular, arcuate or polygonal cross section and may further include an annular or solid cross-section. Support pole 9 has a plurality of holes or receivers 10 along a length of the support pole 9 at various intervals to receive and hold flexible suspension rods 3. Support pole 9 and suspension rod 03 may be colored to camouflage its presence.

In a preferred embodiment, support pole 9 includes an annular cross section with a plurality of holes 10 along its length. A decoy 1 is attached to support pole 9 by inserting a free end 11 of suspension rod 3 into hole 10. The position of decoy 1 may be varied by inserting free end 11 to a greater or lesser extent into hole 10. In another preferred embodiment, support pole 9 includes a number of receivers 10 to receive and hold free end 11. In both embodiments, several decoys 1 may be removably attached to single support pole 9 to simulate a flock of birds.

A lower end 15 of support pole 9 is removably attached to the ground 12 by pushing the lower end 15 into the ground 12. Alternatively a ground stake 13 coupled to lower end 15 allows support pole 9 to be fixed to the ground and may be further configured to swivel or rotate in the presence of wind. As shown in FIG. 2, ground stake 13 fits inside a support pole 9 which has an annular cross section. Likewise, a support pole 9 with a solid cross section at lower end 15 fitted with a receiver 14 adapted to receive ground stake 13 attaches support pole 9 to the ground and allows for swivel or rotation in the wind. In either embodiments, lower end 15 of support pole 9 is placed over ground stake 13. In another embodiment, a decoy 1, is fixed to an upper end 16 of support pole 9.

Referring further to FIG. 2, a plurality of decoys 1 as described in FIG. 1 are shown attached to a support pole 9. When mounted, decoys 1 are free to move vertically and/or horizontally in a light wind and independently of each other.

With respect to the above description, it is to be realized that the optimum dimensional relationships for the parts of the invention, to include variations in size, materials, shape, form, function and manner of operations, assembly and use, are deemed readily apparent and obvious to one skilled in the art, and all equivalent relationships to those illustrated in the drawings, and described in the specification, are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents are considered to fall within the scope of the invention.

I claim:

1. A bird decoy system comprising:
at least one flexible suspension rod with two end regions, said first end region is fixed to a bird decoy and a user determined portion of said second end region is removably positioned in a hole formed in and substantially perpendicular to a longitudinal axis of a substantially vertical support pole, whereby said suspension rod is releaseably and variably positioned adjacent to said support pole and said bird decoy is suspended above a nearby surface to mimic a bird in motion.

2. A bird decoy system as claimed in claim 1, wherein said bird decoy comprises a flat main body portion, a flat head and neck portion, a flat tail portion, and two flat wing portions formed from a piece of substantially flat material and configured to present from a plan view a bird in flight with substantially extended wings.

3. A bird decoy system as claimed in claim 2, wherein said flexible suspension rod extends substantially parallel to a longitudinal axis of said main body portion from said head and neck portion to said support pole.

4. A bird decoy system as claimed in claim 2, wherein said flexible suspension rod extends between said tail portion and said support pole.

5. A bird decoy system as claimed in claim 1, wherein said flexible suspension rod is made of a material selected from the group of metal, plastic, fiberglass and graphite.

6. A bird decoy system comprising:
a support pole releaseably anchored to earth at a first end and extending substantially upward and terminating at a second end, said support pole having at least one mounting receptacle positioned along a length of said support pole to releaseably and variably hold a suspension rod at a first end region, said suspension rod having a second end region fixed to a bird decoy, wherein said bird decoy is suspended above a nearby surface to mimic a bird in flight.

7. A bird decoy system as claimed in claim 6, wherein a second bird decoy is fixed to and supported by said second end of said support pole.

8. A bird decoy system as claimed in claim 6, wherein said support pole is substantially hollow.

9. A bird decoy system as claimed in claim 6, wherein a ground stake coupled to said first end of said support pole anchors said support pole to earth.

10. A bird decoy system as claimed in claim 6, wherein said ground stake is rotatably coupled to said first end of said support pole to allow rotation of said support pole.

11. A bird decoy system as claimed in claim 6, wherein said support pole is semi-flexible and made of a material selected from the group of metal, plastic, fiberglass and graphite.

12. A bird decoy system comprising:
a bird decoy mounted to a suspension rod at a first end region, said suspension rod having a second end region releaseably mounted to and between two ends of a support member resulting in variable positioning of said bird decoy above a nearby surface to mimic a bird in flight.

13. A bird decoy system as claimed in claim 12, wherein said bird decoy comprises a flat unitary outline shape of a top view of a flying bird with outstretched wings, head, neck and body formed from a single piece of substantially flat rigid material;

14. A bird decoy system as claimed in claim 12, wherein said bird decoy is decorated to resemble the markings of a bird.

15. A bird decoy system as claimed in claim 13, wherein a crease is formed in said flat rigid material between said main body and said wings portions to encourage each of said wings to move above and below said main body in the presence of a wind.

16. A bird decoy system as claimed in claim 13, wherein said flat rigid material is corrugated plastic.

17. A bird decoy system as claimed in claim 13, wherein a bend is formed in said flat rigid material between said main body and said wings portions to encourage each of said wings to move above and below said main body in the presence of a wind.

18. A bird decoy system as claimed in claim 13, wherein a plurality of slits are formed in said flat rigid material between said main body and said wind portions to encourage each of said wings to move above and below said main body in the presence of a wind.
